(19) United States
(12) Patent Application Publication
(10) Pub. No.: US 2023/0107788 A1
(43) Pub. Date: Apr. 6, 2023

(54) ENHANCEMENTS TO COOLING MEANS FOR AXIAL FLUX GENERATORS

(71) Applicant: TIME TO ACT LIMITED, Hatfield (GB)

(72) Inventor: Hugh-Peter Granville KELLY, Hatfield (GB)

(21) Appl. No.: 17/788,168

(22) PCT Filed: Dec. 21, 2020
(86) PCT No.: PCT/GB2020/053322

§ 371 Date: Jun. 22, 2022

(30) Foreign Application Priority Data
Dec. 23, 2019 (GB) 1919217.8

(51) Int. Cl. H02K 1/20; H02K 1/18; H02K 3/24

(52) U.S. Cl. CPC H02K 1/20; H02K 1/182; H02K 3/24; H02K 21/24

(57) ABSTRACT

A generator comprising at least one annular stator, the annular stator comprising: an annular plate having an inner circumference and an outer circumference with a series of hollow bosses projecting from a first planar surface of the plate and arranged within and around the outer circumference; and a plurality of coils each located so that a portion is around an associated boss; wherein each hollow boss has an associated recess in a second planar surface of the plate; wherein the generator is constructed and arranged such that the recesses of the hollow bosses are receptive to the induction and passage of cooling fluid in and around the recess.

### CROSS-REFERENCE TO RELATED APPLICATIONS

This application represents the national stage entry of PCT International Patent Application No. PCT/GB2020/053322 filed on Dec. 21, 2020 and claims priority to Great Britain Patent Application No. 1919217.8 filed on Dec. 23, 2019. The contents of each of these applications are hereby incorporated by reference as if set forth in their entirety herein.

### DESCRIPTION

The following disclosure relates to means for further facilitating the cooling of stator coils embodied within stators of axial flux generators, and in particular the cooling of stator coils used within the type of generator described in my co-pending applications nos. GB2,520,516 and GB2538516.

Axial flux generators, especially those of large diameter and high output, are finding use in renewable energy applications, especially the conversion to electricity of mechanical energy harnessed by rotors of axial wind turbines. Current designs are capable of converting to electricity mechanical energy at megawatt or even multiple megawatt levels. In particular so called direct drive generators are receiving especial attention where the generator is driven directly by the turbine, eliminating the need for a gear box.

However, and in common with all electrical machines, heat losses arise from the very act of generation. By far the most prominent of these are electrical heat losses. These arise due to I²R losses in the windings (coils) embodied within the stator of the generator. For example, in a large 5MW capacity generator being run at 90% efficiency, winding losses result in the order of 10%×5MW=0.5MW. This presents a profound problem in terms of dissipating and conducting away this significant and unwanted heat.

High capacity cooling means are required to convey safely away heat from the stator coils in order to avoid their overheating and consequent distortion and/or destruction of the entire stator frame in which they are embodied.

Thus it is often the case that the performance of a high performance generator is determined or limited by the actual degree to which this means of cooling is effective rather than other considerations—such as the rate of electromagnetic conversion of mechanical energy to electrical. Cooling means within this type of generator therefore plays a vital part in generators achieving their maximum output capacity, as well as safe operation. Means for enhancing further the rate of cooling remains a prime objective for designers of this type of generator.

In my co-pending application no. GB2,544,275 “Cooling means for direct drive generators”, hereby incorporated in its entirety by reference, an arrangement is described in which air is forced, or inducted into, or both, a central plenum chamber situated within the centre of one or more annular stators, and then guided by slats in rotor separating collars to egress radially outwards as streams of air over the stator surfaces (and indeed the rotors sandwiching them). Heat radiating axially from the outwardly facing surfaces of coils embodied circumferentially around the stator is thus conducted away by the said streams of air passing radially over them.

In my other co-pending application no. GB18199265.5, hereby incorporated in its entirety by reference, further cooling means are disclosed for providing forced cooling to the peripheral sides surfaces of such coils.

The combinations of those two forms of cooling is effective thereby to provide cooling to both the front and rear surfaces of the coils as well as their sides. However, further increased cooling is desirable.

The present disclosure provides an annular stator comprising: an annular plate having an inner circumference and an outer circumference with a series of hollow bosses projecting from a first planar surface of the plate and arranged within and around the outer circumference; and a plurality of coils each located so that a central portion is around an associated boss; wherein each hollow boss has an associated recess in a second planar surface of the plate.

The present disclosure provides a generator comprising at least one annular stator, the annular stator comprising: an annular plate having an inner circumference and an outer circumference with a series of hollow bosses projecting from a first planar surface of the plate and arranged within and around the outer circumference; and a plurality of coils each located so that a portion is around an associated boss; wherein each hollow boss has an associated recess in a second planar surface of the plate; wherein the generator is constructed and arranged such that the recesses of the hollow bosses are receptive to the induction and passage of cooling fluid in and around the recess.

According to the disclosure, mounting means for coils embodied within a stator of a generator comprise for each coil a hollow boss upon which the (central) portion of the coil is located, the hollow inner portion of each boss being receptive to the induction and passage of cooling means in and around it.

The walls of the boss are thereby cooled, and by heat conduction the inner wall of the coil mounted around it is cooled too. Thus it is possible optionally for all exposed surface areas of the coils, including their innermost turns by the present disclosure to be cooled.

Preferably the cooling means is air.

According to a first aspect of the disclosure, cooling means provided to the boss comprises the same cooling means as is forced radially past and over the side of the stator for cooling the sides of the stator.

By this means, the radially forced cooling means serves conveniently to fulfil two functions, cooling both the planar side of the stator, and the bosses themselves. Two out of the four surfaces of the coil, namely the sides of the coils adjacent the planar side of the stator, and their inner turns, are thus cooled by the same cooling means.

The combination of the forgoing aspects is effective to ensure the interior of the boss is effectively cooled by the cooling means, and thus to convey heat away from the inner turns of the stator coil mounted upon it. This is particularly important in ensuring prevention of “hot-spots”, being those portions of an electrical coil which—though inadequate cooling—can become hot locally, suffer damage and in the process destroy operation of the entire coil.

The disclosure will now be described with reference to the accompanying drawings in which:

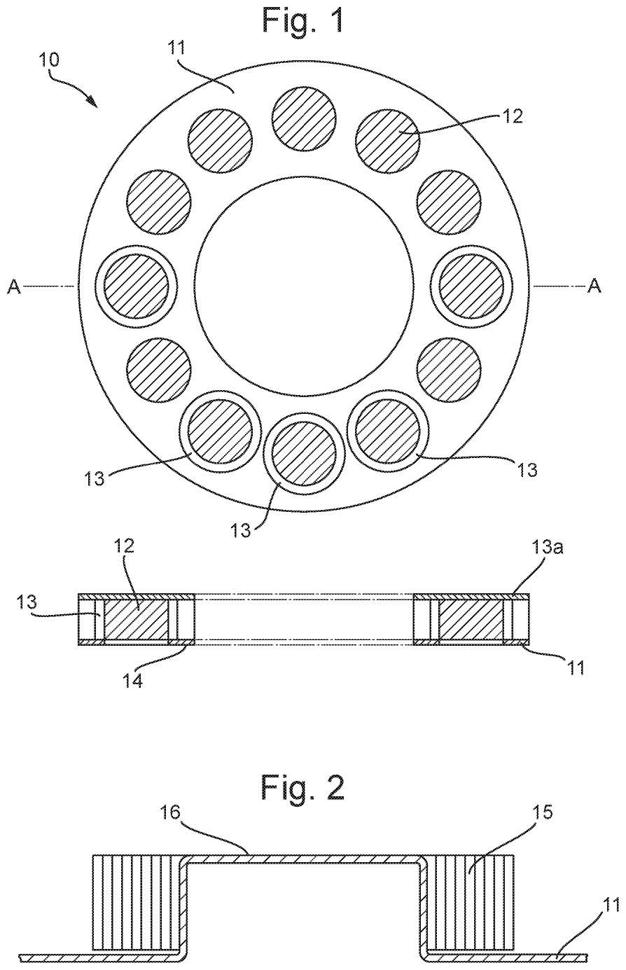

FIG. 1 shows a front view of a stator of the disclosure

FIG. 2 shows an individual coil and boss of FIG. 1 in detail

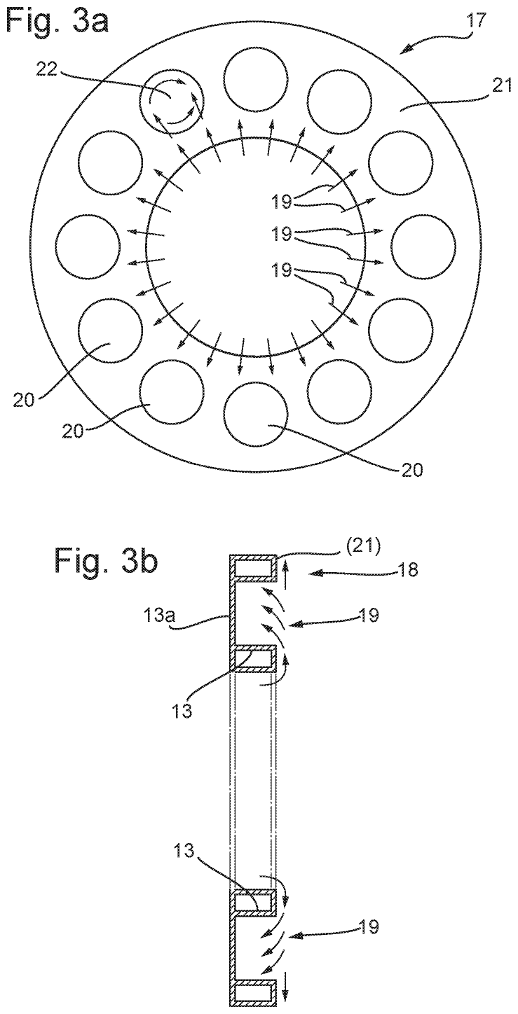

FIG. 3 shows a rear view of the stator, and air flow across it

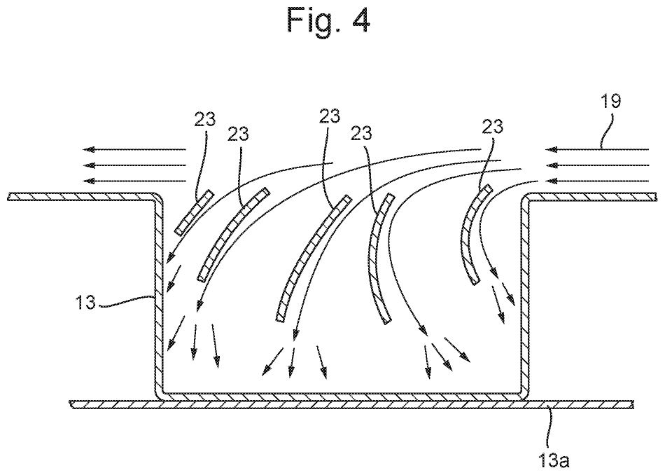

FIG. 4 shows a method of inducing air into the cavity of the boss

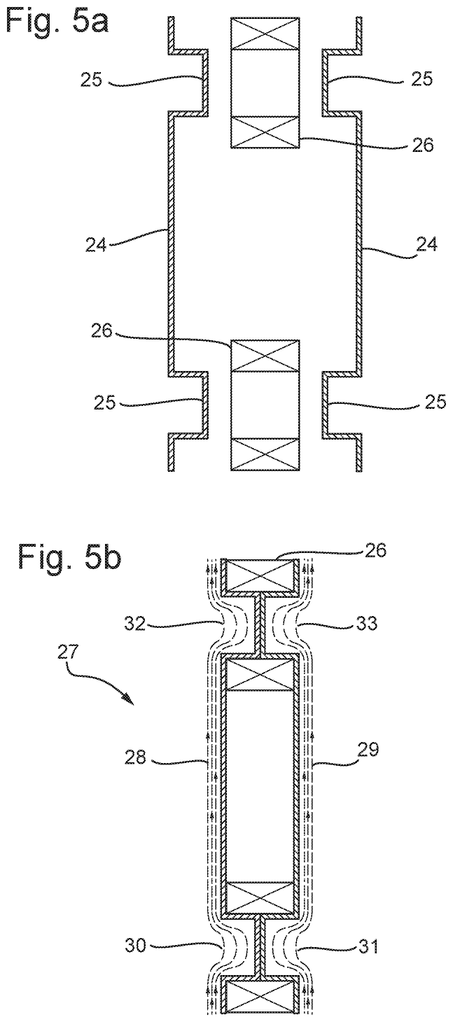

FIG. 5a and FIG. 5b show a schematic cross-section of another embodiment of boss,

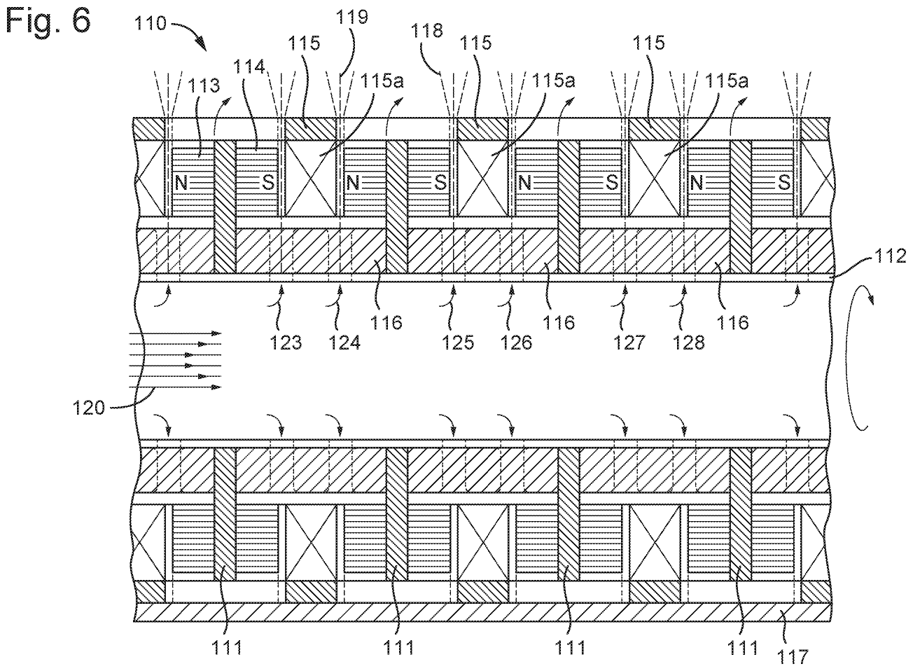

FIG. 6 shows, in cross-section, a direct drive generator embodying gas cooling means; and

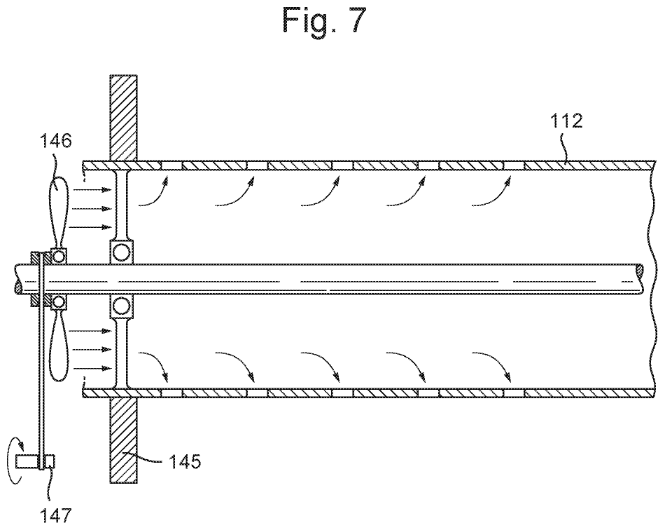

FIG. 7 shows, in cross-section, an arrangement for blowing cooling gas into the generator.

Referring to FIG. 6, a direct drive generator to which the present disclosure can be applied is designated generally at 110. The generator comprises a series of annular rotors 111, carried and mounted upon a central cylinder 112, for rotating relative to fixed stators 15 sandwiched between them. The annular rotors and fixed stators are co-axial. Mechanical means (not shown) is used to convey torque to the cylinder/rotor assembly to effect the said rotation relative to the stators 115. Each of the rotors 111 carries around its outer face an array of permanent magnets as shown at 113 and 114. Opposite poles face one another across the gap between rotors 111 as shown. The stators each carry around their peripheries an array of coils, as shown at 115a. Electricity is generated in the stator coils 115a as the changing lines of magnetic flux passing between facing magnets 113, 114 sweep past them.

For certain applications, for example the use of such a generator to convert wind energy to electricity, very substantial thermal losses can occur. By way of illustration, an eight megawatt generator operating at 95% conversion efficiency leaves 400,000 watts of heat to be dissipated within the stator coil 15a windings. This heat must be conveyed away systematically, in particular away from the stator coils 15a, to avoid hot spots arising and the consequent destruction of the said stator coils 15a.

A method of achieving this as described in GB 2,544,275 is now illustrated again with reference to FIG. 6.

Each of the rotors 111 is held in position relative to the rotors 111 on either side of it by intermediate annular collars, as shown at 116. These rest against the radially inner region of the rotors 111. Draw bolts, not shown, passing longitudinally through the rotors 111 and collars 16 from end to end hold the whole assembly together. The collars 116 are coaxially mounted upon and carried by the central cylinder 112, in similar manner to the rotors 111. Cooling gas (e.g. air) is blown (e.g. pushed or sucked) into the central cylinder 112 as shown by the arrows at 20. The far end of the central cylinder 112 is blocked off (not shown) to prevent escape of the gas. Cooling of the rotors 111 and stators 15 is effected as follows.

Gas vents, provided radially through and circumferentially around the collars 116, are aligned during manufacture with orifices situated along the central cylinder 112. This provides a direct path for gas (e.g. under pressure) within the central cylinder 112 to egress from the central cylinder 112 and out into the gap past the faces of both the rotors 111 and stators 115, as shown by the small arrows in FIG. 6. The outlet of the vents in the radially outermost surface of the collars 111 are axially aligned with one or both axial ends of the stator coils 115a and/or one or both outwardly facing axial ends of the permanent magnets 113, 114. On account of the rotation of the rotors 111, this escaping gas is favourably distributed over the stator 115 surfaces. The gas eventually escapes from the gap between the stator 115 and rotor 111 surfaces as shown at 118 and 119.

This arrangement is satisfactory for generators comprising a relatively short series of pairs of rotors 111 and stators 115, for example three or under. For a longer series, gas pressure within the cylinder 112 naturally can tend to become curtailed both as a result of turbulence and its prior passage through preceding vents.

Means for providing a stream of cooling gas to the generator 110 is now shown with reference to FIG. 7. The cylinder 112 bearing the rotors—one of which is shown for reference at 145—is provided with a (pushing) fan 146, belt driven by an auxiliary electric motor 147. By this means, cooling gas is introduced (pushed) directly into the cavity formed by the cylinder 112.

Preferably, and especially for long series rotor and stator generators, cooling gas is introduced by the use of two (pushing) fans, positioned at each end of the cylinder 112. By this means, double the volume of gas is fed into the cylinder 112 for cooling purposes. The equal feeding of gas from both ends further facilitates the even distribution of gas though the cooling vents.

Referring to FIG. 1 an annular stator 10 comprises a planar surface formed by, for example a plate 11. Pre-formed bosses 12 are present around a circumference of the plate of the annular stator 10. The annular stator 10 has an inner circumference and an outer circumference and the bosses 12 are formed between the inner and outer circumference. Each boss 12 projects from one of the planar surfaces of the plate 11. The bosses 12 are hollow meaning that a recess associated with each boss is formed in the other of the planar surfaces of the plate 11.

As shown, each boss 12 is optionally closed on its front side by a closing face (the side of the plate 11 on which the coil is mounted), as indicated by the hatching. Stator coils as shown at 13 are placed over each boss 12 (only some coils 13 are illustrated as being in place in FIG. 1), the inner side of each coil being in contact with, or substantially close (say within the diameter of the wire from which the coil is made) to, the outer walls of the boss.

Completion of manufacture of the stator is effected by the placing of a cover sheet 13a over the bosses and coils followed by injection of a resin adhesive such as an epoxylite resin, to fill all the voids between the cover sheet 13a and the plate 11. The cover sheet 13a may first be adhered to the closing face of the bosses 12 or the cover sheet 13a may be clamped to the plate 11 whilst the resin is injected. This ensures good thermal contact between the coils 13 and the plate 11 and cover plate 13a sandwiching them, as well as between the inner turns of the coil 13 and the walls of the boss 12 within the coil. A completed stator is depicted across the line A-A in side view elevation schematically at 14.

The resin may be a high thermally conducting resin and/or of the type commonly used in the construction of electric motors and generators. For example the resin can be of an industrial type specifically developed to conduct away heat, for example EIP 4260 available from Elan-tron® sold by Wire Electric Supplies. EIP4260 is a two component epoxy system and has a thermal conductivity of 0.6-0.7 W/mK (ASTM C518). Thus in an embodiment the coils are embedded in a material with a thermal conductivity of at least 0.5 W/mK.

FIG. 2 shows in greater detail, an individual coil 15 mounted over its boss 16 without a cover sheet 13a.

Referring to FIGS. 3a and 3b, a rear view of the stator 10 of FIG. 1 is shown at 17 & 18.

The generator of FIG. 6 comprises a series of spaced annular stators 10 sandwiched between a series of rotors. The rotors are each separated by annular collars. The annular collars define a central cavity. At least one cooling gas source for supplying gas to the central cavity is provided. Vents through the annular collars provide a means of egress for the cooling gas from the central cavity radially outwards over the sides of the rotors and the sides of the annular stators. In this way, a stream of cooling fluid 19, preferably air, is forced radially outwards from the centre of the stator along the sides (axial ends) of the coils for the purpose of cooling the outside surface of the coils as is disclosed in my co-pending application no. GB2,544,275.

According to a further aspect of the disclosure the boss upon which the stator coil is mounted is in a form of a top hat, that is to say, having only one side open, the said open side being substantially in line with the flow of the cooling fluid flowing over and used to cool the sides of the stator. By this arrangement, the stator side cooling means passing radially across the open side of the boss, swirls without escape into the recess within the boss, so as to cool more effectively the sides thereof. The boss protrudes on one side of the plate 11. On the other side of the plate 11 (the rear of the plate 11) the boss is hollow. That means that there is a recess in the rear side of the plate 11. The recess is aligned with the central portion of each coil which is vacant (the coil is in annular form). In an embodiment, the depth of the recess formed by the boss 17 is at least half the width in the axial direction of the associated coil 13. The recess of the boss (i.e. the hollow interior portion) is receptive to the induction and passage of cooling fluid in and around it as illustrated by arrows 22. In an embodiment the generator is assembled so that no other component of the generator is in the recess, i.e. it is empty, so as to allow unrestricted flow of cooling fluid (e.g. air) in the recess. In an embodiment, the boss 12 is monolithic with the plate 11. That is, the plate 11 is formed to have bosses 12 in it, for example by the bosses 12 being punched into or formed protruding from a flat annular plate. Thus the closing face of each boss has substantially the same thickness as the plate 11.

FIG. 5 show a boss of a further embodiment, in cross-section. Here the plate 11 and cover sheet 13a each have a shallow boss formed in them. Thus cooling can occur from both sides. The recess of the boss is at least a third of the width in the axial direction of the associated coil 13. The bosses in both the plate 11 and cover sheet 13a can be seen as having a top hot cross section. The plate 11 and cover sheet 13a could be identical.

Referring to FIGS. 5, 5a and 5b, an arrangement is shown for further facilitating the flow of air to cool the inside of stator coils. Rather than using a single boss for locating a coil, there are two symmetrical stator faces, 24, as shown in FIG. 5a, upon which are formed bosses 25 having substantially half the axial depth of a coil as compared to those shown at 12 in FIG. 1 (which occupy substantially a full coil depth). Stator coils are shown schematically at 26.

When the two halves are bonded together, as shown at 27 in FIG. 5b, each coil sits astride the two half bosses. By this means, cooling air, 28 and 29, travelling radially as before across the stator faces, can now be inducted more effectively by virtue of their lesser depth into the half cavities presented by the four bosses 30,31,32 and 33. Thereby the boss interiors —and hence the coils borne by them, are cooled more effectively.

The plate 11 and/or cover sheet 13a may be made of fibre glass.

The open side face 20 of each boss is arranged to be in line with (co-planar) the outside face 21 of the stator. This arrangement permits the cooling fluid, (hereinafter referred to as air), to reach into the central cavity within each boss as shown at 22 and, in the process of swirling around it, cool the periphery of the boss and thus encourage heat transfer therethrough from the inner turns of the coil.

In practice it is desirable to deflect as much air as possible into the boss cavity. A method of doing so is indicated at FIG. 4, in which vanes 23 positioned strategically across the cavity increase the induction of the cooling air within it, and thus more propitious cooling of its inner periphery. The cavity within the boss may be fitted with vanes, so angled as to induce further the passage of the cooling means into and generally around the interior of the boss. In this way gas flow is directed into the corners of the recess where otherwise gas could stagnate. In an embodiment, the vanes 23 protrude from the plane of the planar surface of the plate 11 thereby to catch cooling fluid flowing along the planar surface and deflected into the recess formed by the boss.

In an embodiment, the boss does not have a closing face or the closing face has one or more openings in it. In an embodiment, the cover sheet 13a has one or more openings in it which align with the opening of the boss or any openings in the closing face of the boss. This permits cooling fluid to flow from one side of the stator to the other.

In an embodiment the at least one annular stator has at least one cooling gap for the flow of cooling fluid in the annular stator between adjacent coils of the plurality of coils, the at least one cooling gap having an inner opening in the inner circumference and an outer opening in the outer circumference in a way substantially as described in GB18199265.5.

In an embodiment the at least one cooling gap accommodates a sealed channel for conveying the cooling fluid.

In an embodiment the sealed channel is formed of a non-magnetic material with a thermal conductivity of at least 0.5 W/mK, preferably at least 1 W/mK, more preferably at least 10 W/mK.

Numerous variations will be apparent to those skilled in the art.

1. A generator comprising at least one annular stator, the annular stator comprising:
an annular plate having an inner circumference and an outer circumference with a series of hollow bosses projecting from a first planar surface of the plate and arranged within and around the outer circumference; and
a plurality of coils each located so that a portion of the coil is around an associated boss;
wherein each hollow boss has an associated recess in a second planar surface of the plate;
wherein the generator is constructed and arranged such that the recesses of the hollow bosses are receptive to the induction and passage of cooling fluid in and around the recess.

2. The generator of claim 1 wherein the at least one annular stator further comprises a cover sheet, the coils being sandwiched between the cover sheet and the plate.

3. The generator of claim 1 or 2, wherein the coils are embedded in a material with a thermal conductivity of at least 0.5 W/mK.

4. The generator of claim 1, 2 or 3, wherein the bosses have, in cross-section, the form of a top hat.

5. The generator of any of claims 1 to 4, wherein a depth of the recesses of the bosses is at least a third of the axial width of the coils, preferably half of the axial width of the coils.

6. The generator of any of claims 1 to 5, wherein the at least one annular stator further comprises vanes, optionally passing radially across the open side of the boss, for directly cooling fluid flowing parallel to the plate into the associated hollow.

7. The generator of any of claims 1 to 6, wherein the at least one annular stator further comprises at least one cooling gap for the flow of cooling fluid in WO 2021/130478 PCT/GB2020/053322 the annular stator between adjacent coils of the plurality of coils and extending from the inner circumference to the outer circumference.

8. The generator of any of claims 1-7, wherein the plate and hollow bosses of each annular stator are monolithic.

9. A generator of any preceding claim comprising:
a series of said at least one annular stator spaced apart and each sandwiched between two of a series of rotors, the rotors each being separated by annular collars, the annular collars defining a central cavity; at least one cooling gas source for supplying gas to the central cavity; vents through the annular collars for providing a means of egress for the cooling gas from the central cavity radially outwards over the rotors and the annular stators.

10. The generator of claim 9, wherein the vents are constructed and arranged such that in use the cooling gas from the vents enters the recess.

11. The generator according claim 9 or 10, wherein the at least one cooling gas source comprises one or more fans for forcing cooling gas into the central cavity.

12. The generator of claim 11, further comprising a central shaft on which the rotors and annular collars are carried; and
the one or more fans are mounted on the central shaft.
